(19) United States
(12) Patent Application Publication
(10) Pub. No.: US 2022/0274020 A1
(43) Pub. Date: Sep. 1, 2022

(54) METHOD AND APPARATUS FOR SWITCHING GAME CHARACTER, AND ELECTRONIC DEVICE

(71) Applicant: Shanghai Ingot Network Technology Co., Ltd., Shanghai (CN)

(72) Inventors: Zhiqin Xu, Shanghai (CN); Mei Peng, Shanghai (CN)

(21) Appl. No.: 17/364,852

(22) Filed: Jun. 30, 2021

Related U.S. Application Data
(63) Continuation of application No. PCT/CN2021/097382, filed on May 31, 2021.

(30) Foreign Application Priority Data
Feb. 26, 2021 (CN) 202110223586.8

(51) Int. Cl. A63F 13/58; A63F 13/42; G06F 3/0481; G06F 3/0484

(52) U.S. Cl. CPC A63F 13/58; A63F 13/42; G06F 3/04817; G06F 3/04842

(57) ABSTRACT

A method and apparatus for switching a game character, and an electronic device are disclosed. The method includes: receiving, when a first character is on a game interface of a game process, a character switching instruction on a game interface that displays a first character; acquiring character data corresponding to a second character according to the character switching instruction; and switching the first character to the second character on the game interface according to the character data.

### CROSS REFERENCE TO RELATED APPLICATIONS

The present application is a Continuation application of PCT Application No. PCT/CN2021/097382 filed on May 31, 2021, which claims the benefit of Chinese Patent Application No. 202110223586.8 filed on Feb. 26, 2021. All the above are hereby incorporated by reference in their entirety.

### TECHNICAL FIELD

The present disclosure relates to the technical field of computers, and in particular, to a method and apparatus for switching a game character, and an electronic device.

### BACKGROUND

Third Personal Shooter (TPS) games are shooter games from God's perspective, in which players can see their characters walking and making attacking movements and enjoy a strong sense of action.

In the scenario of a TPS game, a player is generally required to perform a wider variety of operations. However, the player can only experience the fun of a single character in a single round of TPS game, making the game less interesting. To solve the above problem, the existing TPS game can be made more interesting by pausing the game process and returning to a character switching page to select a new game character. However, this operation is complex, and multiple jumps between interfaces may require the main thread to load a large amount of data or load a lot of user interface (UI) elements, resulting in a page jump delay. Moreover, when the GPU usage of the interface is too high, multiple jumps between pages may cause the cutscenes to be unsmooth and slow, resulting in poor user experience.

### SUMMARY

An objective of the present disclosure is to solve one of the technical problems in the prior art, and to provide a method and apparatus for switching a game character, and an electronic device, to reduce the data loading amount and GPU usage during switching of a game character, thereby improving user experience.

An embodiment of the present disclosure provides a method for switching a game character, including:

receiving, when a first character is on a game interface of a game process, a character switching instruction on a game interface that displays a first character;

acquiring character data corresponding to a second character according to the character switching instruction; and

switching the first character to the second character on the game interface according to the character data.

Further, the step of receiving, when a first character is on a game interface of a game process, a character switching instruction on the game interface that displays the first character includes:

detecting a controlling status of the first character when the first character is on the game interface of the game process; and

receiving, when the first character is in a controllable state, the character switching instruction on the game interface that displays the first character.

Further, receiving the character switching instruction on the game interface that displays the first character includes:

receiving the character switching instruction on the game interface through a target control icon.

Further, the character switching instruction is generated after a click operation on the target control icon is completed in a display area of the target control icon.

Further, after receiving the character switching instruction on the game interface through the target control icon, the method further includes:

setting the target control icon to be in a non-selectable state within a preset duration.

Further, the method further includes:

replacing the target control icon with an icon of the preset duration in the display area, to display the icon of the preset duration in the display area.

Further, the step of receiving, when a first character is on a game interface of a game process, a character switching instruction on the game interface that displays the first character includes:

detecting the character data when the first character is on the game interface of the game process;

receiving, on the game interface that displays the first character, the character switching instruction through the target control icon when the character data exists; and

hiding the target control icon when the character data does not exist.

Further, switching the first character to the second character includes:

switching the first character to the second character at a current position of the first character.

Further, after switching the first character to the second character, the method further includes:

highlighting an associated area of the second character on the game interface.

Further, the character data includes at least one of image data of the second character, health point data of the second character, and output value data of the second character.

Further, an embodiment of the present disclosure provides an apparatus for switching a game character, including:

an instruction receiving module, configured to receive, when a first character is on a game interface of a game process, a character switching instruction on the game interface that displays the first character;

a data acquiring module, configured to acquire character data corresponding to a second character according to the character switching instruction; and

a character switching module, configured to switch the first character to the second character on the game interface according to the character data.

Further, an embodiment of the present disclosure provides an electronic device, including a display screen, a memory, a processor, and a computer program stored in the memory and operable on the processor, wherein the processor, when executing the program, implements the method for switching a game character described in the foregoing embodiment.

Further, an embodiment of the present disclosure provides a computer readable storage medium, storing a computer executable instruction, wherein the computer executable instruction causes a computer to perform the method for switching a game character described in the foregoing embodiment.

Compared with the prior art, in the foregoing embodiments, by receiving the character switching instruction on the game interface of the game process and directly switching the first character to the second character according to the character switching instruction, character switching can be completed without multiple interface jump operations, thereby avoiding the problem of a jump delay or an unsmooth cutscene caused by multiple jumps between interfaces, reducing the data loading amount and GPU usage during game character switching, and improving the game experience of users in the TPS game.

The foregoing embodiments improve the smoothness of game running by detecting the controlling status of the first character and receiving the character switching instruction when the first character is in the controllable state.

In the foregoing embodiments, the character switching instruction is received on the game interface through the target control icon. In this case, the character switching instruction sent by the player can be received through the target control icon on the game interface or through an area associated with the first character or the second character. When the character switching instruction sent by the player is received through the target control icon, the area associated with the first character or the second character can be hidden when necessary.

In the foregoing embodiments, the character switching instruction is generated after the player completes the click operation on the target control icon through the display area of the target control icon, thus avoiding false switching caused by accidentally touching the target control icon.

In the foregoing embodiments, the target control icon is set in the non-selectable state within the preset duration after the character switching instruction is received on the game interface through the target control icon, thus avoiding frequent character switching operations caused by triggering the target control icon frequently.

In the foregoing embodiments, when there is no character data, the target control icon is hidden, to avoid unnecessary consumption of computing resources and prevent the target control icon without control function from occluding the map background on the game interface.

In the foregoing embodiments, the first character is switched to the second character at the current position of the first character, such that the game interface can use the current map background of the first character. Only the character data of the second character needs to be loaded, and there is no need to load the map background, thereby reducing the data loading amount or buffer pressure of a user terminal.

### BRIEF DESCRIPTION OF DRAWINGS

The present disclosure is further described below with reference to the accompanying drawings and embodiments.

FIG. 1 is a schematic diagram of a game switching method in the prior art;

FIG. 2 is a diagram of an application environment of a method for switching a game character according to an embodiment;

FIG. 3 is a diagram of another application environment of a method for switching a game character according to an embodiment;

FIG. 4 is a schematic flowchart of a method for switching a game character according to an embodiment;

FIG. 5 is a schematic diagram of a game interface before a character switching instruction is received;

FIG. 6 is a schematic diagram of a game interface after a character switching instruction is received;

FIG. 7 is a schematic diagram of a game interface after a target control icon is hidden;

FIG. 8 is a partial schematic diagram of a game interface;

FIG. 9 is a schematic structural diagram of an apparatus for switching a game character according to an embodiment; and

FIG. 10 is a structural block diagram of a computer device according to an embodiment.

### DETAILED DESCRIPTION

The specific embodiments of the present disclosure are described in detail herein. The preferred embodiments of the present disclosure are shown in the accompanying drawings. The accompanying drawings are used to supplement the description of the textual part of the specification with graphics, so that each technical feature of the present disclosure and the overall technical solution can be understood intuitively and vividly, but the accompanying drawings should not be understood as a limitation on the protection scope of the present disclosure.

Third Personal Shooter (TPS) games are shooter games from God's perspective, in which players can see their characters walking and making attacking movements and enjoy a strong sense of action.

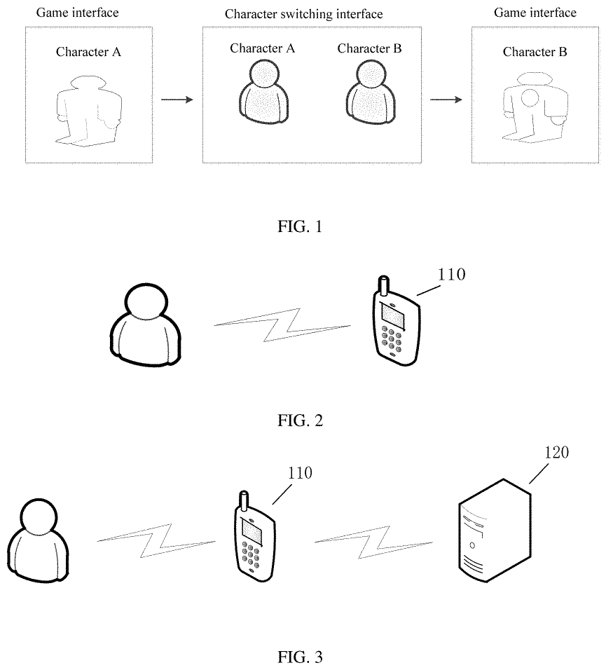

In the conventional TPS game, generally, a player can only experience the fun of a single character in a single round of game. To switch to another character, the user needs to wait until the current round of game is ended, and then select the new character, which will definitely result in poor game experience of the user. To improve user experience, as shown in FIG. 1, the game process can be suspended in some existing TPS games, for example, a game level or task being executed by a current game character A can be suspended, a new game character B can be selected after returning to a character switching interface, and then a game interface of the game process can be redirected to allow the re-selected game character B to continue with the current game level or task. In such a game character switching operation, the game process currently being executed needs to be suspended first, so as to return to the character switching interface to select a game character, and then jump to the game interface of the game process, which is tedious. Moreover, during jumping between pages, if the redirected interface includes a large amount of data (e.g., during a jump from the character switching interface to the game interface that includes a large amount of data), a large amount of data needs to be loaded, which leads to a page jump delay. Alternatively, if the redirected interface needs to load a lot of UI elements (e.g., during a jump from the game interface to the character switching interface that needs to load a lot of characters and other UI elements), a page jump delay will be caused. In addition, when the graphics processing unit (GPU) of the game interface or character switching interface is used at an excessively high frequency, the cutscene is unsmooth and slow during jumping between pages.

To solve the foregoing technical problems, FIG. 1 shows a diagram of an application environment of a method for switching a game character according to an embodiment. Referring to FIG. 2, the method for switching a game character is applied to a user terminal 110. The user terminal 110 may be an independent user terminal such as a cell phone, a tablet computer, a laptop computer, a wearable device, or a desktop computer. In the user terminal 110, when a first game character is on a game interface of a game process, a user sends a character switching instruction by operating the game interface on the user terminal 110, where the operation may be clicking, downward sliding or text inputting. The user terminal, upon receiving the character switching instruction sent by the user through the game interface, pulls pre-stored character data and switches the first character to a second game character on the game interface based on the character data. The first character and the second character are player characters that can be manipulated by the player in the TPS game. In this embodiment, the character data is pre-stored in the memory of the user terminal. Upon receiving the user-initiated character switching instruction on the game interface, the user terminal can directly retrieve character data for forming the second character from the memory, to complete the character switching. There is no need to acquire the character data online, so that the user terminal can still complete the character switching in an offline state.

In an embodiment, FIG. 3 shows a diagram of another application environment of a method for switching a game character according to an embodiment. In this application environment, a user terminal 110 is connected to a server 120 via a network, and the terminal 110 may specifically be a desktop terminal 110 or a mobile terminal 110, and the mobile terminal may be one of a cell phone, a tablet computer, a laptop computer, a wearable device, etc. The server 120 may be implemented by an independent server 120 or a server cluster composed of multiple servers 120, or may be a cloud server providing basic cloud computing services such as cloud services, a cloud database, cloud computing, cloud functions, cloud storage, network services, cloud communications, middleware services, domain name services, security services, CDN, and big data and artificial intelligence platforms. In this embodiment, the user terminal 110 may be used as the front end of a game client running the game, and the server 120 may be used as the back end of the game client. In this way, the server 120 can quickly establish a long connection with the user terminal 110 after acquiring a remote connection request sent by the game user in the user terminal 110 through the game client.

When receiving a character switching instruction, the user terminal 110 sends the character switching instruction to the server 120, such that the server 120 acquires character data according to the character switching instruction and sends the character data to the user terminal 110. The user terminal 110 switches the first character to the second character on the game interface based on the character data sent by the server. In this embodiment, upon receiving the user-initiated character switching instruction on the game interface, the user terminal requests, from the server through the communication network, the character data for forming the second character, to complete the character switching. There is no need to pre-store the character data locally, thereby reducing the storage pressure of the user terminal.

Since the rendering of virtual scenes consumes a certain amount of performance, a caching mechanism is introduced before the character switching. That is, a map background on the game interface is cached in the user terminal 110 or the server 120. When the character switching occurs, the cached map background can be found directly based on the map background during the character switching, so that historical rendering data mapped by the cached map background will be quickly used as virtual rendering data of the map background to be rendered in the current switching. It means that once the map background on the game interface has been rendered, the map background can be directly retrieved from the cache at the time of the character switching without performing rendering calculation for the map background again, thereby greatly reducing the consumption and occupation of physical rendering resources in the user terminal or the server. It can be understood that switching the first character to the second character means switching the first character to the second character directly on the game interface, without jumping to other pages. In order to avoid lagging of the game interface caused by switching of too many characters, switching the first character to the second character is generally implemented between two game characters. When the performance of the user terminal or the server is excellent, switching the first character to the second character may be implemented among multiple game characters, and the specific number of game characters that can be involved in character switching is not limited herein.

By receiving the character switching instruction on the game interface of the game process and directly switching the first character to the second character according to the character switching instruction, character switching can be completed without multiple interface jump operations, thereby avoiding the problem of a jump delay or an unsmooth cutscene caused by multiple jumps between interfaces, reducing the data loading amount and GPU usage during game character switching, and improving the game experience of users in the TPS game.

The method for switching a game character provided in the embodiments of the present disclosure will be illustrated in detail below through several specific embodiments.

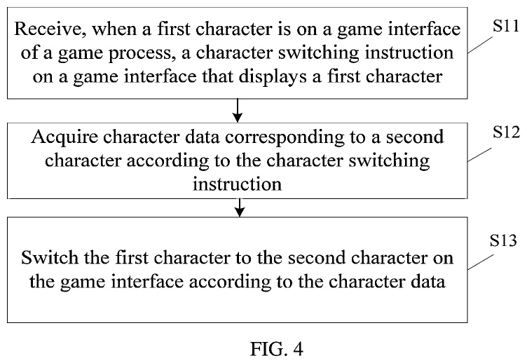

As shown in FIG. 4, in an embodiment, a method for switching a game character is provided. This embodiment is mainly described with an example in which the method is applied to a computer device. The computer device specifically may be the user terminal 110 in FIG. 1.

Referring to FIG. 4, the method for switching a game character specifically includes the following steps:

S11: receive, when a first character is on a game interface of a game process, a character switching instruction on a game interface that displays a first character.

S12: acquire character data corresponding to a second character according to the character switching instruction.

S13: switch the first character to the second character on the game interface according to the character data.

By receiving the character switching instruction on the game interface of the game process and directly switching the first character to the second character according to the character switching instruction, character switching can be completed without multiple interface jump operations, thereby avoiding the problem of a jump delay or an unsmooth cutscene caused by multiple jumps between interfaces, reducing the data loading amount and GPU usage during game character switching, and improving the game experience of users in the TPS game.

The first character is a player character that can be manipulated by a player in a TPS game, or consists of both a player character that can be manipulated by a player and a secondary character associated with the player character to assist the player character in the in-game combat. The game process is a game level or task being executed by the first character controlled by the user, and the game interface is an interface formed on the screen of the user terminal when the first character is in the game level or game task. When the first character is on the game interface of the game process, the user terminal can receive a character switching instruction from the player through a virtual button on the game interface or through the game interface itself. In the case that the user terminal receives the character switching instruction from the player through the virtual button on the game interface, the player may click on a predetermined area on the game interface, for example, clicking on associated areas of the first character and the second character on the game interface. Generally character information of the character, such as a character avatar, is displayed on the associated area. When the player performs an operation, e.g., clicks on the associated area displaying the second character information, the character switching instruction is received. It can be understood that, if the first character is on the game interface and does not need to be switched, even though the player clicks on the associated area displaying the first character, it is obvious that the character switching is not necessary, and thus the association area of the first character may be set to be in a disabled state. The character switching operation will not be triggered when the player clicks on the associated area of the first character, thus preventing the user terminal from loading data repeatedly. Alternatively, when the user terminal receives the character switching instruction from the player through the game interface, whether the character switching instruction sent by the player is received may be determined by detecting a sliding operation performed by the player on the game interface. For example, when an upward sliding operation, a downward sliding operation, a leftward sliding operation, a rightward sliding operation or any other sliding operation performed by the player on the game interface is detected, it is determined that the character switching instruction is received.

In the game process, there are usually some demos demonstrating the game plot in the process, such as interaction between a non-player character (NPC) and a player character. Such interaction is performed with the player character currently controlled by the player, i.e. the first character. If the character switching occurs at this point, the interaction may be suspended due to the change of the character, and thus the demo screen is skipped or a logic error occurs in the game process, which affects the smoothness of the game process. To ensure the smoothness of the game process while considering the fact that the first character is usually uncontrollable by the user when the demo screen appears, in an embodiment, the step of receiving, when the first character is on the game interface of the game process, the character switching instruction on the game interface that displays first character includes:

detecting a controlling status of the first character when the first character is on the game interface of the game process. The controlling status indicate whether the first character can respond to a movement operation made on a virtual wheel on the game interface or an attack operation made by the player in real time. For example, if the player makes a leftward movement operation on the virtual wheel on the game interface, the first character can move to the left side of the game interface in real time in response to the leftward movement operation, and in this case, it is determined that the first character is in a controllable state; otherwise, it is determined that the first character is in an uncontrollable state. When the first character is in the controllable state, the user terminal can receive the character switching instruction on the game interface that displays the first character; otherwise, the user terminal stops receiving character switching instructions on the game interface, and when the player sends a character switching instruction, the user terminal does not receive the instruction. By detecting the controlling status of the first character and receiving the character switching instruction when the first character is in the controllable state, the smoothness of game running is improved.

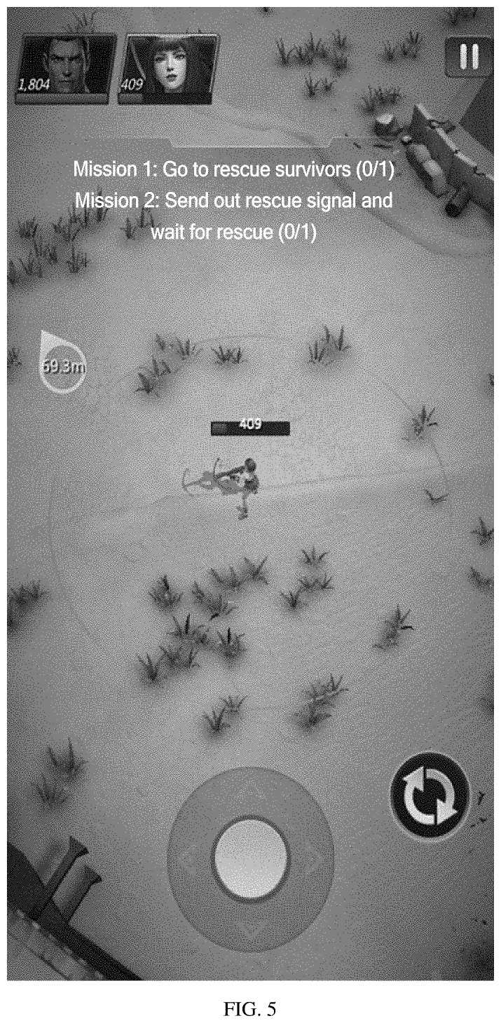

To further facilitate player operations, in an embodiment, the step of receiving the character switching instruction on the game interface that displays the first character includes: receiving the character switching instruction on the game interface through a target control icon. In this case, the character switching instruction sent by the player can be received through the target control icon on the game interface. The character can be switched without using an area associated with the first character or the second character, such that the area associated with the first character or the second character can be hidden when necessary. Meanwhile, the operation on the virtual wheel also causes sliding of the game interface. Therefore, the method of receiving the character switching instruction by detecting sliding of the game interface may cause incorrect reception of the character switching instruction. Such occasions may be reduced by receiving, through the target control icon, the character switching instruction sent by the player. As shown in FIG. 5, the target control icon may be located on one side of the virtual wheel, and a display area of the target control icon may be a circular area to facilitate the operation of the user. Understandably, the display area can also be square, triangular or in other conventional shapes, which are not described in detail herein. Upon detecting that the player is operating on the target control icon, the target control icon may be zoomed in for a short period of time to indicate that the player is operating the target control icon. At the same time, the user terminal receives a character switching instruction that is generated when the player clicks on the target control icon. In an embodiment, the character switching instruction is generated after the player completes a click operation on the target control icon in the display area of the target control icon, where the click operation means that it is detected that the player has touched the target control icon in the display area and the touch on the game interface is ended in the display area. If it is detected that the player has touched the target control icon in the display area, but the touch on the game interface is not ended in the display area, no character switching instruction will be generated. This method allows the user to slide out of the display area of the target control icon to end the touch when touching the target control icon on the game interface accidentally, thereby avoiding false switching caused by the accidental touch on the target control icon.

In an embodiment, after the step of receiving the character switching instruction on the game interface through the target control icon, the method further includes: setting the target control icon to be in a non-selectable state within a preset duration.

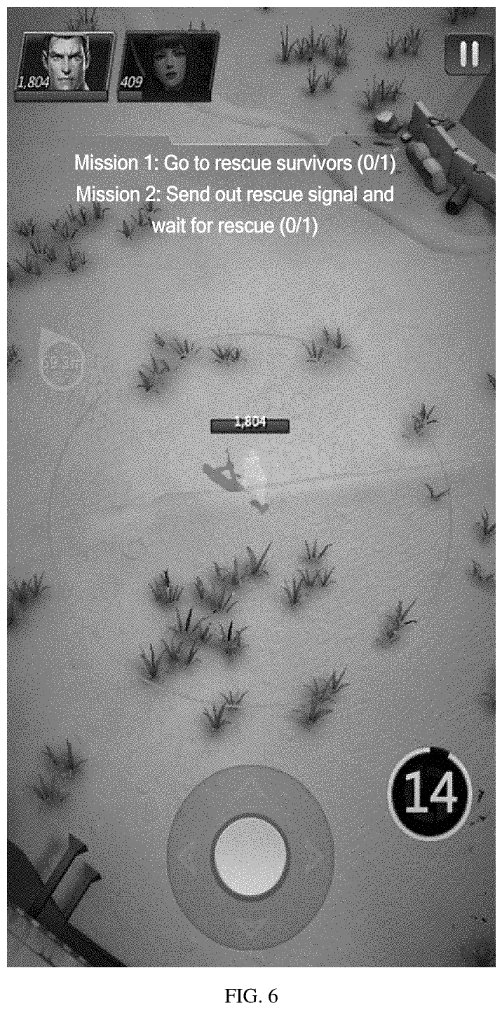

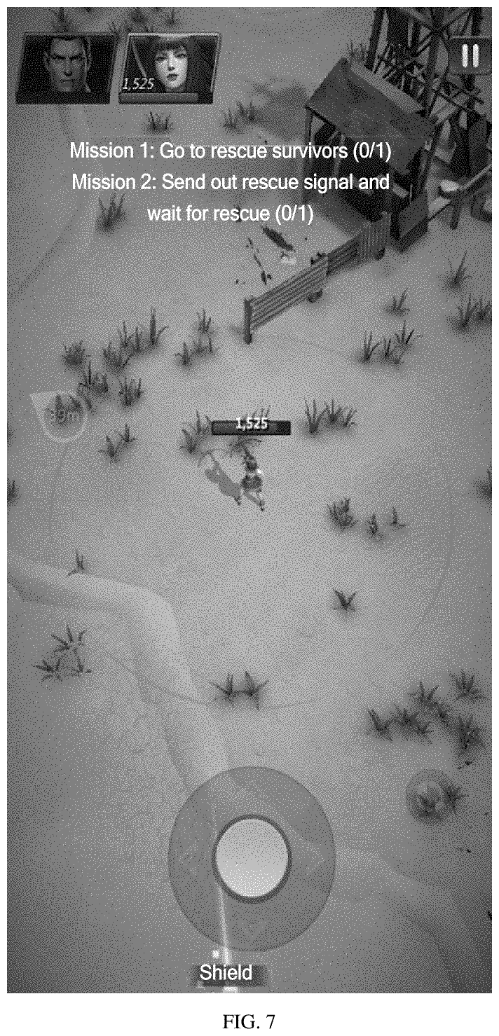

Frequent touches on the target control icon may cause frequent character switching, which requires the user terminal to perform frequent data computation within a short period of time, thus consuming excessive resources of the user terminal or causing the game process to crash due to frequent data computation. To avoid this problem, the target control icon is set to be non-selectable within a preset duration after the character switching instruction is received on the game interface through the target control icon. The non-selectable state means that the target control icon stops receiving information or information received by the target control icon is discarded, i.e., no character switching instruction can be generated by clicking on the target control icon within the preset duration. The preset duration may be set according to the actual demand, which may be 10 to 20 seconds, such as 15 seconds, to avoid a long waiting time of the player. To achieve a prompt effect, in one embodiment, when the target control icon is in the non-selectable state, the target control icon is replaced with an icon of the preset duration in the display area of the target control icon, to display the preset duration in the display area. As shown in FIG. 6, the target control icon is replaced with the icon of the preset duration. That is, the target control icon in the display area is replaced with a digital image containing a preset duration, where the digital image is optionally a dynamic digital image for a better prompt effect. The digital image shows a digital countdown timer effect in the display area. When the preset duration has passed, the timer effect disappears. At this point, the display area is switched back to the target control icon, and the target control icon is controlled to start receiving information or to stop discarding the information received by the target control icon.

In TPS games, the game character may “be killed in action”. If the character switching instruction is generated by the target control icon when the character dies, the character switching cannot be performed, but the user terminal still searches for the character data in response to the character switching instruction, which results in unnecessary consumption of computing resources. In addition, the displayed target control icon blocks the map background in the game interface. Therefore, in an embodiment, the step of receiving, when the first character is on the game interface of the game process, the character switching instruction on the game interface that displays first character includes: detecting the character data when the first character is on the game interface of the game process; wherein the character data includes at least one of the following data: image data of the second character, health point data of the second character, and output value data of the second character; receiving, on the game interface that displays the first character, the character switching instruction through the target control icon when the character data exists; and hiding the target control icon when the character data does not exist.

When a game character “dies”, the user terminal or the server deletes data of the game character from the current game process, and there is no second character that can be switched to. When no character data is detected, the target control icon is hidden, including semi-hidden or completely hidden. FIG. 7 shows an example in which the user terminal semi-hides the target control icon. The target control icon is set to be non-selectable, i.e. no character switching instruction can be generated by clicking on the target control icon.

The game interface includes not only the game characters but also the map background. Loading or rendering of the map background consumes certain resources during the character switching. Even if the caching mechanism is used, it still causes certain pressure on the cache of the terminal, and the cache of the user terminal is under greater pressure especially when there are too many map backgrounds. Therefore, in an embodiment, the step of switching the first character to the second character includes:

switching the first character to the second character at a current position of the first character. The first character is switched to the second character at the current position of the first character, such that the game interface can still use the map background of the current first character. Only the character data of the second character needs to be loaded, and there is no need to load the map background, thereby reducing the data loading amount or buffer pressure of the user terminal.

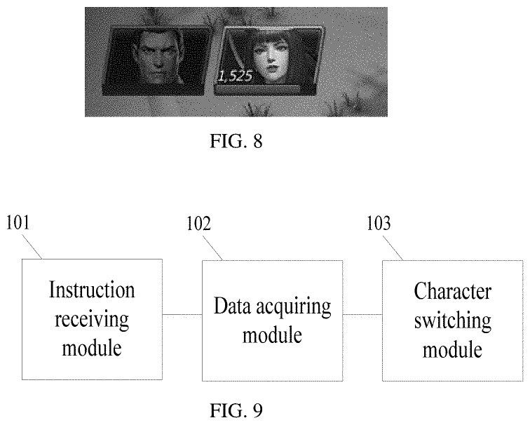

To achieve a better prompt effect, in an embodiment, an associated area of the second character is highlighted on the game interface after the first character is switched to the second character. As shown in FIG. 8, the associated area of the first character is a game avatar and health point data of the first character, and the associated area of the second character is a game avatar and health point data of the second character. After the user terminal switches the first character to the second character, the game avatar and health point data of the first character are displayed in weakened manner, and the game avatar and health point data of the first character are highlighted. The weakened display may be to reduce the brightness or the resolution of the display area corresponding to the game avatar and health point data of the first character; the highlighting may be to increase the brightness or resolution of the display area corresponding to the game avatar and health point data of the second character, such that the brightness and resolution are significantly higher than those of the game avatar and health point data of the first character.

In an embodiment, as shown in FIG. 9, an apparatus for switching a game character is provided, including:

an instruction receiving module 101, configured to receive, when a first character is on a game interface of a game process, a character switching instruction on a game interface that displays a first character;

a data acquiring module 102, configured to acquire character data corresponding to a second character according to the character switching instruction; wherein the character data includes at least one of the following data: image data of the second character, health point data of the second character, and output value data of the second character; and

a character switching module 103, configured to switch the first character to the second character on the game interface according the character data.

In an embodiment, the instruction receiving module 101 is specifically configured to: detect a controlling status of the first character when the first character is on the game interface of the game process; and receive, when the first character is in a controllable state, the character switching instruction on the game interface that displays the first character.

In an embodiment, the instruction receiving module 101 is further configured to: receive the character switching instruction on the game interface through a target control icon. The character switching instruction is generated after a click operation on the target control icon is completed in a display area of the target control icon.

In an embodiment, the instruction receiving module 101 is further configured to: set the target control icon to be in a non-selectable state within a preset duration after receiving the character switching instruction on the game interface through the target control icon.

In an embodiment, the instruction receiving module 101 is further configured to: replace the target control icon with an icon of the preset duration in the display area, to display the preset duration in the display area after setting the target control icon to be in the non-selectable state within the preset duration.

In an embodiment, the instruction receiving module 101 is further configured to: detect the character data when the first character is on the game interface of the game process; receive, on the game interface that displays the first character, the character switching instruction through the target control icon when the character data exists; and hide the target control icon when the character data does not exist.

In an embodiment, the character switching module 103 is specifically configured to: switch the first character to the second character at a current position of the first character.

In an embodiment, the character switching module 103 is further configured to: highlight an associated area of the second character on the game interface.

In this embodiment of the present disclosure, the instruction receiving module 101, the data acquiring module 102, and the character switching module 103 each may be one or more processors or chips that have a communication interface to implement a communications protocol, and may further include a memory and relevant interfaces, a system transmission bus, and the like if necessary. The one or more processors or chips execute program-related code to implement corresponding functions. Alternatively, the instruction receiving module 101, the data acquiring module 102, and the character switching module 103 may share an integrated chip or share a processor, a memory, a display and other devices. The shared processor or chip executes the program-related code to implement the corresponding functions.

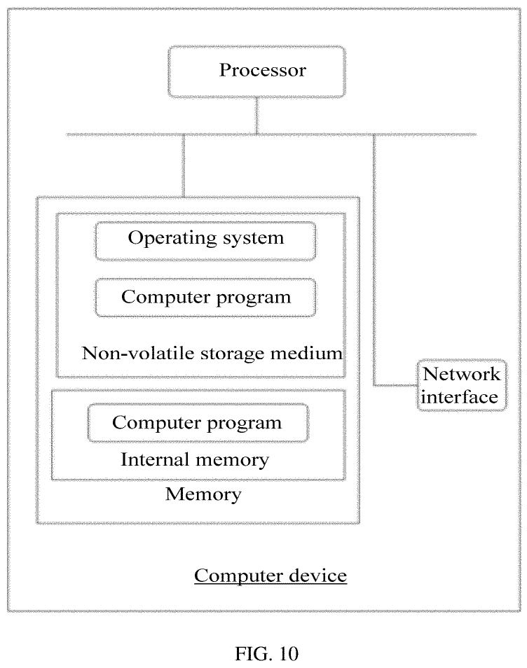

In an embodiment, an electronic device, i.e., a computer device is provided. As shown in FIG. 10, the computer device includes a processor, a memory, a network interface, an input apparatus and a display screen that are connected through a system bus. The memory includes a non-volatile storage medium and an internal memory. The non-volatile storage medium of the computer device stores an operating system, and may also store a computer program. The computer program, when executed by the processor, causes the processor to implement the method for switching a game character. The internal memory may also store a computer program. The computer program, when executed by the processor, may cause the processor to perform the method for switching a game character. Those skilled in the art may understand that the structure shown in FIG. 10 is only a block diagram of a partial structure related to the solution of the present disclosure and does not constitute a limitation on the computer device to which the solution of the present disclosure is applied. Specifically, the computer device may include more or fewer components than those shown in the figure, or some components may be combined, or a different component arrangement may be used.

In an embodiment, the apparatus for switching a game character provided in the present disclosure may be implemented in the form of a computer program. The computer program may be run on the computer device shown in FIG. 10. The memory of the computer device may store various program modules forming the apparatus for switching a game character. The computer program formed by the program modules causes a processor to perform the steps of the method for switching a game character according to the embodiments of the present disclosure as described in this specification.

In an embodiment, a computer readable storage medium is provided. The computer readable storage medium stores a computer executable instruction, wherein the computer executable instruction causes a computer to perform steps of the foregoing method for switching a game character. The steps of the method for switching a game character herein may be steps in the method for switching a game character in the foregoing embodiments.

The above merely describes preferred embodiments of the present disclosure. It should be noted that, several improvements and modifications may be made by those of ordinary skill in the art without departing from the principle of the present disclosure, and these improvements and modifications should also be considered within the scope of protection of the present disclosure.

Those of ordinary skill in the art may understand that all or some of the procedures in the methods of the foregoing embodiments may be implemented by a computer program instructing related hardware. The program may be stored in a computer readable storage medium. When the program is executed, the procedures in the embodiments of the foregoing methods may be performed. The storage medium may be a magnetic disk, an optical disc, a read-only memory (ROM), a RAM, or the like.

1. A method for switching a game character, comprising:
receiving, when a first character is on a game interface of a game process, a character switching instruction on a game interface that displays a first character;
acquiring character data corresponding to a second character according to the character switching instruction; and
switching the first character to the second character on the game interface according to the character data.

2. The method for switching a game character according to claim 1, wherein the step of receiving, when a first character is on a game interface of a game process, a character switching instruction on the game interface that displays the first character comprises:
detecting a controlling status of the first character when the first character is on the game interface of the game process; and
receiving, when the first character is in a controllable state, the character switching instruction on the game interface that displays the first character.

3. The method for switching a game character according to claim 1, wherein the step of receiving the character switching instruction on the game interface that displays the first character comprises:
receiving the character switching instruction on the game interface through a target control icon.

4. The method for switching a game character according to claim 2, wherein the step of receiving the character switching instruction on the game interface that displays the first character comprises:
receiving the character switching instruction on the game interface through a target control icon.

5. The method for switching a game character according to claim 3, wherein the character switching instruction is generated after a click operation on the target control icon is completed in a display area of the target control icon.

6. The method for switching a game character according to claim 4, wherein the character switching instruction is generated after a click operation on the target control icon is completed in a display area of the target control icon.

7. The method for switching a game character according to claim 3, after receiving the character switching instruction on the game interface through the target control icon, further comprising:
setting the target control icon to be in a non-selectable state within a preset duration.

8. The method for switching a game character according to claim 4, after receiving the character switching instruction on the game interface through the target control icon, further comprising:
setting the target control icon to be in a non-selectable state within a preset duration.

9. The method for switching a game character according to claim 7, further comprising:
replacing the target control icon with an icon of the preset duration in the display area, to display the preset duration in the display area.

10. The method for switching a game character according to claim 8, further comprising:
replacing the target control icon with an icon of the preset duration in the display area, to display the preset duration in the display area.

11. The method for switching a game character according to claim 3, wherein the step of receiving, when the first character is on the game interface of the game process, the character switching instruction on the game interface that displays the first character comprises:
detecting the character data when the first character is on the game interface of the game process;
receiving, on the game interface that displays the first character, the character switching instruction through the target control icon when the character data exists; and
hiding the target control icon when the character data does not exist.

12. The method for switching a game character according to claim 4, wherein the step of receiving, when the first character is on the game interface of the game process, the character switching instruction on the game interface that displays the first character comprises:
detecting the character data when the first character is on the game interface of the game process;
receiving, on the game interface that displays the first character, the character switching instruction through the target control icon when the character data exists; and
hiding the target control icon when the character data does not exist.

13. The method for switching a game character according to claim 1, wherein the step of switching the first character to the second character comprises:
switching the first character to the second character at a current position of the first character.

14. The method for switching a game character according to claim 1, after switching the first character to the second character, further comprising:
highlighting an associated area of the second character on the game interface.

15. The method for switching a game character according to claim 1, wherein the character data comprises at least one of image data of the second character, health point data of the second character, and output value data of the second character.

16. An apparatus for switching a game character, comprising:
an instruction receiving module, configured to receive, when a first character is on a game interface of a game process, a character switching instruction on a game interface that displays a first character;
a data acquiring module, configured to acquire character data corresponding to a second character according to the character switching instruction; and
a character switching module, configured to switch the first character to the second character on the game interface according to the character data.

17. An electronic device, comprising a display screen, a memory, a processor, and a computer program stored in the memory and operable on the processor, wherein the processor, when executing the program, implements the method for switching a game character as defined in claim 1.

18. A computer readable storage medium, storing a computer program, wherein the computer program is suitable to be loaded and executed by a processor, to cause a computer device having the processor to perform the method as defined in claim 1.
